(19) United States
(12) Patent Application Publication
(10) Pub. No.: US 2012/0280627 A1
(43) Pub. Date: Nov. 8, 2012

(54) Garden Light

(76) Inventors: Xing Jian Wei, San Francisco, CA (US); Karen H. Norman, Bolton (CA)

(21) Appl. No.: 13/465,726

(22) Filed: May 7, 2012

Related U.S. Application Data
(60) Provisional application No. 61/483,377, filed on May 6, 2011.

(51) Int. Cl. H05B 37/02

(52) U.S. Cl. 315/159

(57) ABSTRACT

A garden light including a movable display device and a solar powered light is provided. A control element is in electrical communication with the movable display device and the solar power light. The control element is operable to adjust control the movable display device and the solar powered light based on an ambient light input. When the ambient light input is above a threshold level, the control element activates the movable display device. When the ambient light input is below the threshold level, the control element deactivates the solar powered light.

### CROSS-REFERENCE TO RELATED APPLICATION

This application claims the benefit of U.S. provisional Application No. 61/483,377 filed May 6, 2011, the disclosure of which is incorporated in its entirety by reference herein.

### TECHNICAL FIELD

The present disclosure relates to a solar garden light including a display device creating the effect of a flying object.

### SUMMARY

In one embodiment of the present disclosure, a garden light is provided. The garden light includes a movable display device and a solar powered light. A control element is in electrical communication with the movable display device and the solar power light. The control element is operable to adjust control the movable display device and the solar powered light based on an ambient light input. When the ambient light input is above a threshold level, the control element activates the movable display device. When the ambient light input is below the threshold level, the control element deactivates the solar powered light.

In another embodiment of the present disclosure, the control element deactivates the movable display device when the ambient light input is below the threshold level so that movable display device does not move.

In yet another embodiment of the present disclosure the control element activates the solar powered light when the ambient light input is below the threshold level so that the light turns on.

In a further embodiment of the present disclosure, the control element includes a photoelectric control element with a light sensor configured to detect ambient light, the light sensor generating a signal responsive to the detected ambient light.

In another embodiment of the present disclosure, the photoelectric control element further includes a light detection control circuit in communication with the light sensor, the control circuit generating an output in response to the threshold of ambient light.

In yet another embodiment of the present disclosure, the garden light includes a simulated flower portion. The electro-motor is located in a central cavity of the flower portion.

In another embodiment of the present disclosure, the garden light includes a solar panel disposed along a stem.

In a further embodiment of the present disclosure, the light is disposed in a housing of the electro-motor.

In another embodiment of the present disclosure, the moveable display device includes an electro-motor and a simulated insect. When the electro-motor rotates, the insect simulates flying.

In yet another embodiment of the present disclosure, the insect is attached to the electro motor with a flexible wire.

In another embodiment of the present disclosure the solar powered light includes a light-emitting diode (LED).

In one other embodiment of the present disclosure, a garden light is provided. The garden light includes a movable display device and a solar powered light. The garden light includes a controller in electrical communication with the movable display device and the solar power light. The controller is operable to adjust control the movable display device and the solar powered light based on an ambient light input. The controller provides a first control setting when the ambient light input is above a threshold level and provides a second control setting when the ambient light input is below the threshold level.

### BRIEF DESCRIPTION OF THE DRAWINGS

FIG. 1 is an environmental perspective view of the garden light during the daylight when the flying insect is activated and the light is off;

FIG. 2 is an environmental perspective view of the garden light during the night when the flying insect is stopped and the garden light is on, illuminating the flower;

FIG. 3 is a side view of the garden light;

FIG. 4 is a top perspective view of the garden light;

FIGS. 5-6 are a side perspective view of the garden light;

FIG. 7 illustrates a flowchart detailing the method of operating the garden light using a photoelectric control apparatus;

FIG. 8 is a side view of the garden light according to an alternate embodiment;

FIG. 9 is a front perspective view of the garden light according to an alternate embodiment;

FIG. 10 is a top perspective view of the garden light according to an alternate embodiment; and

FIG. 11 is a bottom perspective view of the garden light according to an alternate embodiment.

### DETAILED DESCRIPTION

As required, detailed embodiments of the present invention are disclosed herein; however, it is to be understood that the disclosed embodiments are merely examples of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Referring to the Figures, a garden light 10 according to one embodiment is provided having a simple wireless installation with no cords or plugs since the garden power is from the solar panel. The garden light 10 is designed to enhance the appearance of a home or garden beautiful lighting effects at night and by simulating fluttering insect effects during the day.

The garden light includes an artificial winged insect 12 which is rotationally driven by a solar powered electro-motor 20 to simulate flight of insects. The insect 12 may be a butterfly, a bee, a dragonfly or other similar winged insect. The insect 12 may be connected to the garden light 10 with a wire 14. The winged insect may be connected at the first upper 16 end of the wire while the second end 18 of the wire 14 is connected to the garden light.

The garden light includes an electro-motor 20 to provide movement of the winged insect. The electro-motor 20 may include a spinning disk 22 extending from a rod 24 from one end of the motor housing 26. The wire 14 may be connected to the garden light 10 along the spinning disk 22. The wire 14 may be connected along a periphery 28 of the spinning disk or at any suitable mounting location on the spinning disk 22 so that when the spinning disk 22 rotates the winged insect 12 rotates respectively. The spinning disk 22 is driven by the electro-motor 20.

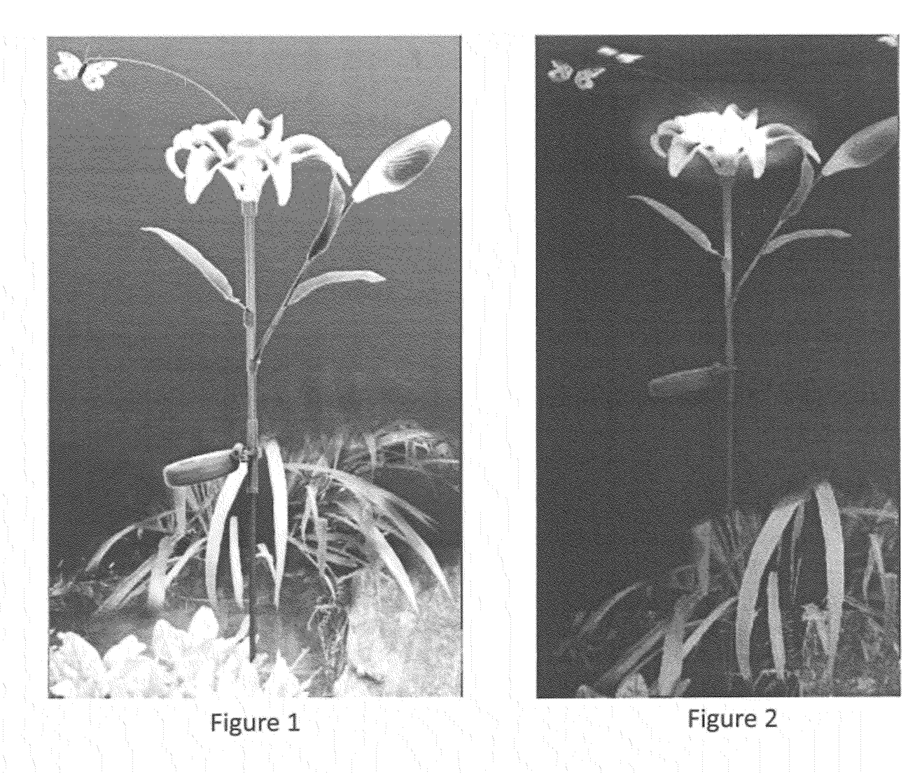

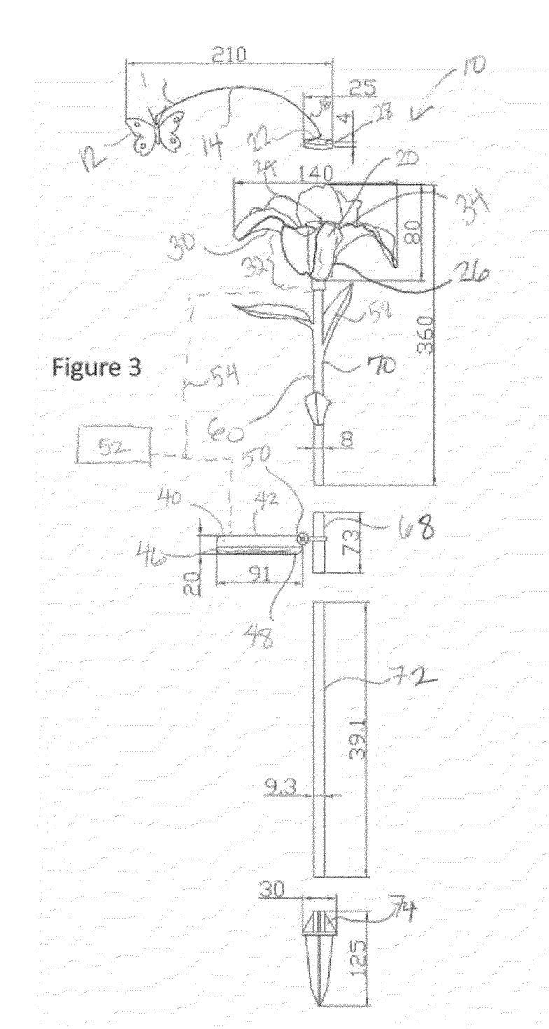

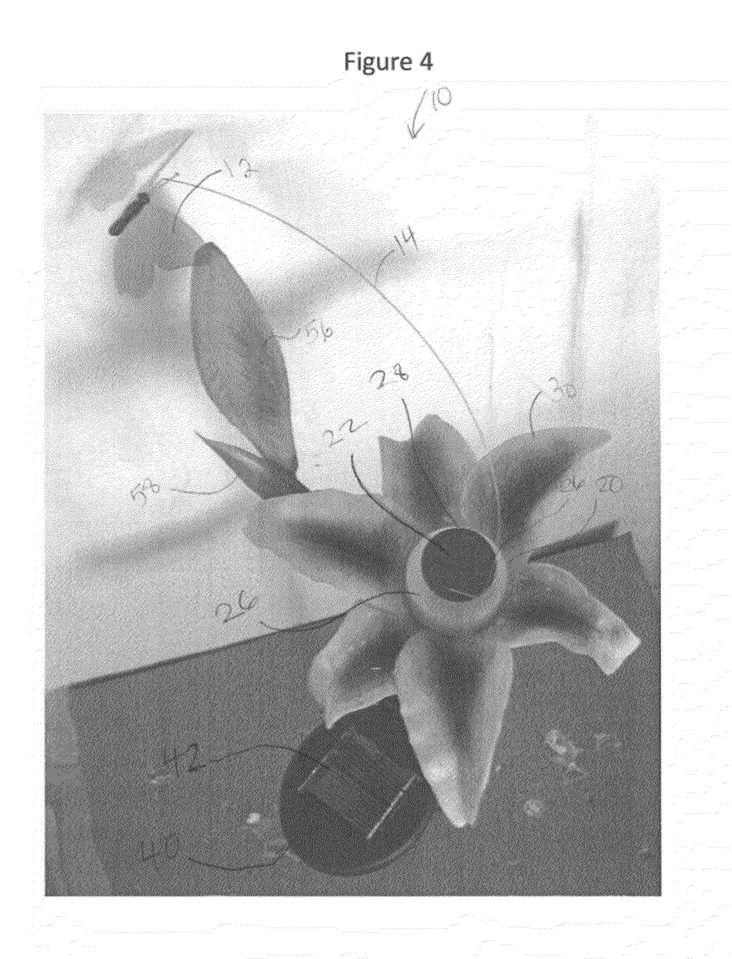

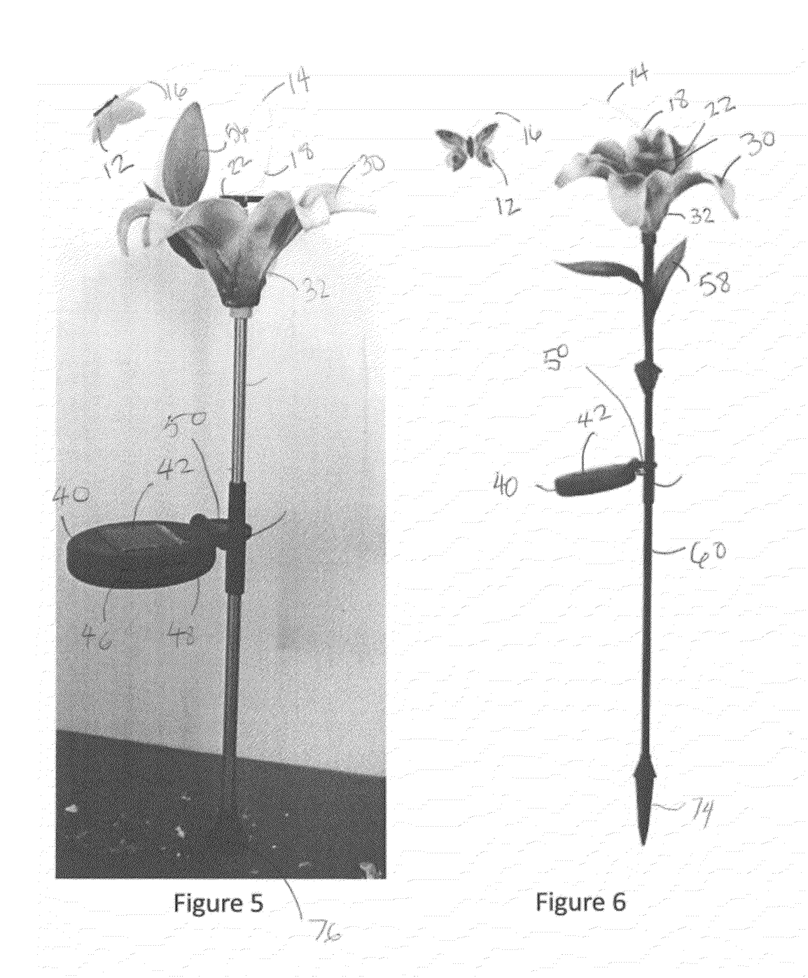

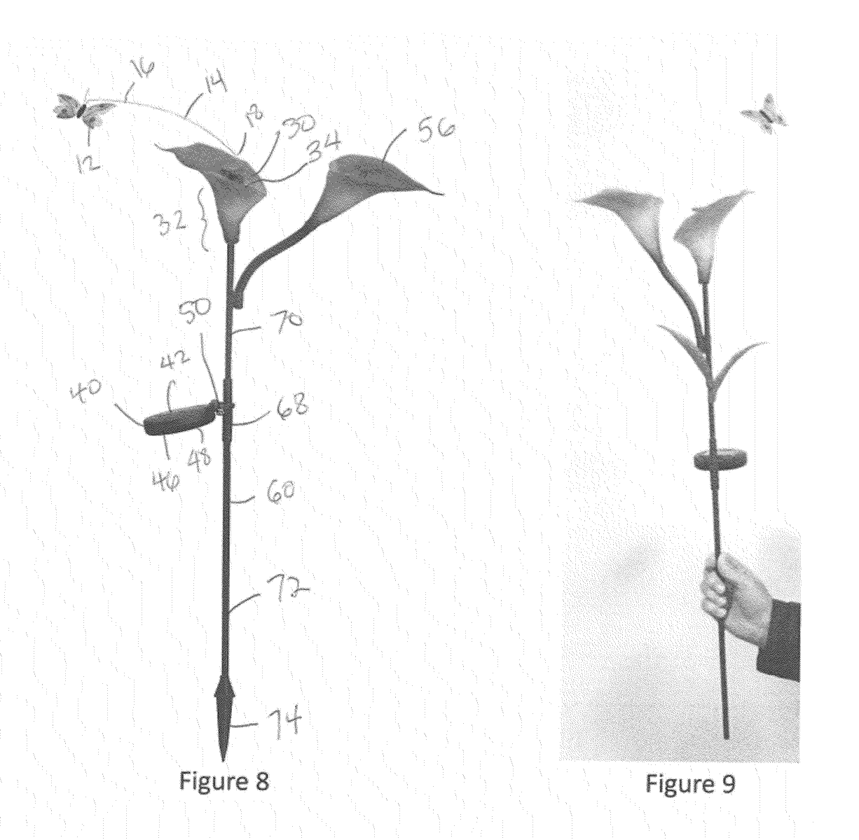

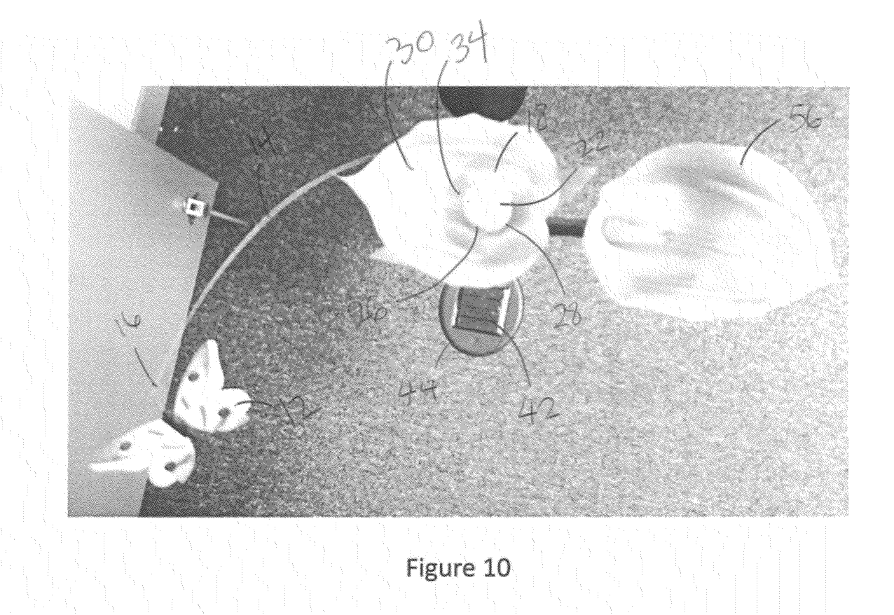

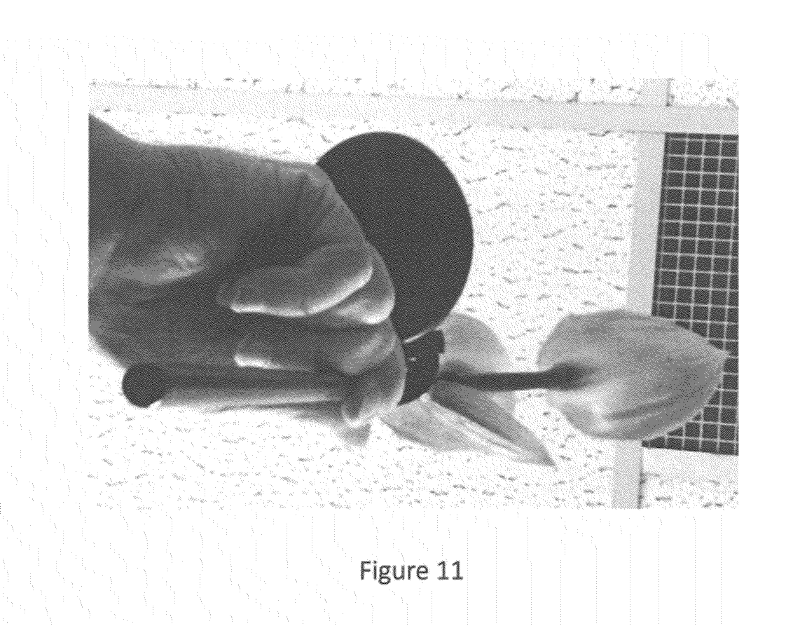

The garden light 10 includes a flower portion 30 is shaped and colored to look like a flower. The electro-motor 20 is connected to and sitting inside the artificial flower 30. In one embodiment, the flower 30 may be shaped and colored like a day lily, as shown in FIGS. 1-6. In another embodiment, the flower portion 30 may be shaped and colored similar to a calla lily, as shown in FIGS. 8-11. However, any suitable flower design is contemplated. In one embodiment, the flower portion 30 may be formed of plastic. Alternatively, the flower portion 30 may be formed of glass, or any other suitable material.

The flower portion 30 may have an elongated throat region 32 in order to enclose the electro-motor 20 in a center cavity 34 of the flower 30. The throat region 32 may conceal the electro-motor 20 from view. The electro-motor 20, being located at the center of the flower 30 may be made to look like a center of a flower, such as the stamen or pistil of a flower. The housing 26 of the electro-motor 30 and the spinning disk 22 may be formed of colors and shaped to further simulate the center portion of the flower.

The electro-motor 20 is powered by a solar panel 40 attached to the garden light 10. When the garden light 10 is placed in a garden under direct sunlight, the electro-motor 20 powered by the solar panel 40 starts to rotate the spinning disk 22 with the wire 14 attached to the flying insect 12. The upper end 16 of the wire is bent so the butterfly trails in the direction of rotation of the spinning disk 22. The wire produces a particularly life-like swinging movement of the flying insect.

The solar panel 40 includes a plurality of solar cells 42 for converting solar energy into electricity. The solar cells 42 may be photovoltaic cells for converting solar energy into electricity, or any suitable solar cell for collecting solar energy.

At the same time the solar cells provide electricity to electro-motor 20, the solar cells also charge a battery 46 inside a battery compartment 48. The battery 46 may be a rechargeable battery such as a nickel metal hydride battery or any other suitable rechargeable battery. The battery 46 and battery compartment may be located below the solar cells 42.

The garden light 10 may also include a sensor 50 for detecting ambient light. The sensor 50 may be a photoelectric sensor. The sensor 50 may be connected to a controller 52. The controller 52 may include a control circuit 54 for generating an output in response to a threshold level of ambient light. The sensor 50 and controller 52 may provide photoelectric control and operation of the electro-motor 20 and garden light 10.

The sensor 50 and controller 52 provide photoelectric control and operation of the garden light 10. During daylight, when the ambient light is above a threshold level, the photoelectric control allows the electric power generated by the solar cells 42 to operate the electro-motor 20 in order to operate the insect 12, such as a fluttering butterfly, during the daylight hours. In the daylight hours the photoelectric controller 52 automatically turns the light 10 off. And as the sun goes down during the evening and the ambient light falls below a threshold level, the photoelectric controller 52 turns the electro-motor 20 off and automatically turns on the solar light 10 to provide illumination at night. By turning off the motor 20, the solar cell 52 and battery 46 may provide enough energy to power the light 10 for up to eight hours or more.

The light 10 may be a light emitting diode (LED). The LED light may provide up to eight hours of light from the charge in the battery 46. The light 10 may be located inside of a housing of the electro-motor. The housing 26 of the electro-motor 20 may be generally transparent in order to allow the light 10 to shine through the housing 26 and illuminate through the artificial flower portion 30. In another embodiment, the light may be located on a different part of the garden light such as an artificial flower portion 30, bud 56 or leaf 58 or other artificial object attached to the garden light 10.

The garden light 10 includes a stem 60 to which the motor 20, flower portion 30 and solar panel 40 may be attached. The stem 60 may be formed of metal, or plastic or any other suitable material for mounting the garden light. The stem may also include a lower stake portion 62 for mounting the garden light 10 in the soil. Alternatively, the stem 60 may include a foot portion 64 for placing the garden light on a level surface such as a walkway or flooring. The stem 60 may be colored and shaped to look like the stem of a flower.

The stem 60 may be formed of a plurality of stem portions 66 which may be connected together to form the stem 60. The stem portions 66 may be separated for easy packaging and storage of the garden light 10. The solar panel 40 may be attached to one of the stem portions 66. The solar panel 40 may be attached to a middle stem portion 68 and may attach to a top stem portion 70 including the electro-motor 20 and flower portion 30. A lower stem portion 72 having the stake 74 or foot 76 may also be attached to the middle stem portion 68. The solar panel 40 may be rotatable with respect to the stem 60 for easy packaging and storage, as well as positioning the solar panel 40 in the sunlight. But locating the solar panel 40 along the middle portion 68 of the stem 60, the solar panel 40 may be shaped and colored to look like a leaf or bud of the flower.

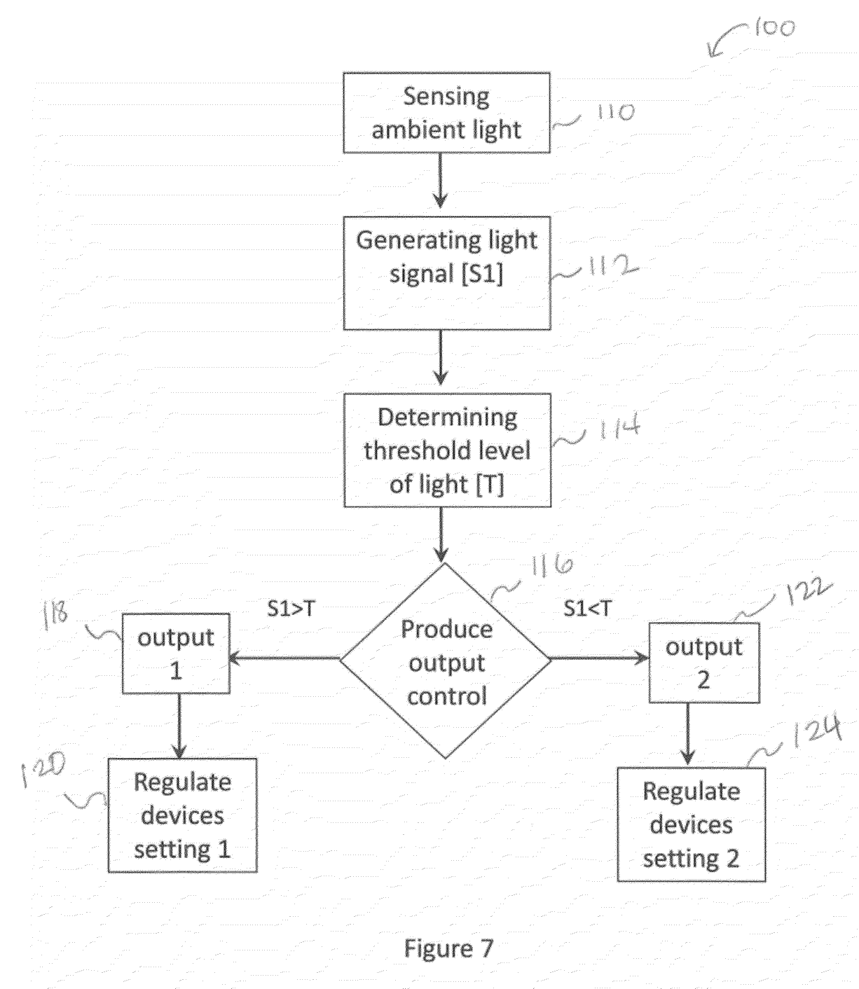

Referring to FIG. 7, a method of controlling the garden light is illustrated in flowchart 100. The ambient light conditions adjacent the garden light 10 are sensed, as represented by block 110. The ambient light may be sensed with sensor 50 or any suitable photovoltaic apparatus. A signal (S1) is generated in response to the sensed ambient light, as represented by block 112. The signal (S1) may be generated by the sensor 50, the photoelectric controller 52 and a combination of sensors and controllers, as a person of ordinary skill in the art would understand.

A threshold level (T) of ambient light is determined, as represented by block 114. The threshold level of light may be a predefined value, or may be a combination of factors such as time of day, for example.

Based on the threshold level (T) of light, the controller 52 produces an output control, as represented by block 116. If the sensed ambient light signal (S1) is greater than the threshold level (T), then the controller produces a first output, as represented by block 118. Based on the first output signal, the controller regulates the devices to a first setting, as represented by block 120. For example, if the ambient light signal (S1) is greater than the threshold level (T), this may indicate a daytime condition so the controller activates the motor 20 and turns off the solar light 10 during the daytime. During the daytime hours when the ambient light signal (S1) is greater than the threshold level (T), the controller activates the motor to turn the disk 22 and simulate the flying insect 12.

If the sensed ambient light signal (S1) is less than the threshold level (T), then the controller produces a second output, as represented by block 122. Based on the second output signal, the controller regulates the devices to a second setting, as represented by block 124. For example, if the ambient light signal (S1) is less than the threshold level (T), this may indicate a nighttime condition so the controller deactivates the motor 20 and turns on the solar light 10 during the nighttime. During the nighttime hours when the ambient light signal (S1) is less than the threshold level (T), the controller activates the light 10 to provide lighting in dark or low light below the threshold level (T).

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A garden light comprising:
a movable display device;
a solar powered light; and
a control element in electrical communication with the movable display device and the solar power light, and operable to adjust control the movable display device and the solar powered light based on an ambient light input,
wherein the control element activates the movable display device when the ambient light input is above a threshold level and the deactivates the solar powered light when the ambient light input is below the threshold level.

2. The garden light according to claim 1 wherein the control element deactivates the movable display device when the ambient light input is below the threshold level so that movable display device does not move.

3. The garden light according to claim 1 wherein the control element activates the solar powered light when the ambient light input is below the threshold level so that the light turns on.

4. The garden light according to claim 1 wherein the control element includes a photoelectric control element with a light sensor configured to detect ambient light, the light sensor generating a signal responsive to the detected ambient light.

5. The garden light according to claim 4 wherein the photoelectric control element further includes a light detection control circuit in communication with the light sensor, the control circuit generating an output in response to the threshold of ambient light.

6. The garden light according to claim 1 further comprising a simulated flower portion, and wherein the display device further comprises an electro-motor is located in a central cavity of the flower portion.

7. The garden light according to claim 6 further comprising a solar panel disposed along a stem supporting the flower portion.

8. The garden light according to claim 6 wherein the solar powered light is disposed in a housing of the electro-motor.

9. The garden light according to claim 1 wherein the movable display device comprises an electro-motor and a simulated insect, wherein when the electro-motor rotates, the insect simulates flying.

10. The garden light according to claim 1 wherein the insect is attached to the electro-motor with a flexible wire.

11. The garden light according to claim 1 wherein the solar powered light further comprises a light-emitting diode (LED).

12. A garden light comprising:
a movable display device;
a solar powered light; and
a controller in electrical communication with the movable display device and the solar power light, and operable to adjust control the movable display device and the solar powered light based on an ambient light input,
wherein the controller provides a first control setting when the ambient light input is above a threshold level and provides a second control setting when the ambient light input is below the threshold level.

13. The garden light according to claim 12 wherein in the first setting, the controller activates the movable display device and deactivates the solar powered light; and when the ambient light input is below the threshold level, the controller deactivates the movable display device and activates the solar powered light.
